(19) United States
(12) Patent Application Publication
(10) Pub. No.: US 2014/0310970 A1
(43) Pub. Date: Oct. 23, 2014

(54) TAPE MEASURE WITH INTEGRATED SCRIBABLE AND EFFACEABLE SURFACE

(71) Applicants: Greg Unmann, Hawthorne, NY (US); Peter Zoesch, Succasunna, NJ (US); Peter J. Esser, Alexandria, VA (US)

(72) Inventors: Greg Unmann, Hawthorne, NY (US); Peter Zoesch, Succasunna, NJ (US); Peter J. Esser, Alexandria, VA (US)

(21) Appl. No.: 13/865,591

(22) Filed: Apr. 18, 2013

(51) Int. Cl. G01B 3/10

(52) U.S. Cl. CPC G01B 3/1071
USPC 33/770

(57) ABSTRACT

A scribable, mechanically self-effaceable note pad which may be marked using only a digit or with any writing implement or scribing tool is secured to a tape measure of the type including a rigid housing and a ruled tape reel provided within the housing, capable of being dispensed and retracted back into the housing through a horizontal aperture formed in one of the end walls. The note pad adheres to any wall or walls of the housing of the tape measure, and may be readily marked and effaced repeatedly and replaced as necessary over time.

### CROSS REFERENCE TO RELATED APPLICATIONS

This application claims the benefit of co-pending U.S. Provisional Application No. 61/635,567 filed Apr. 19, 2012, which is hereby incorporated herein.

### BACKGROUND OF THE INVENTION

This invention relates generally to combination tools, and more particularly to a pressure-sensitive, effaceable note pad which requires neither scribing tool nor writing implement or styles, and which is releasably attachable to a standard tape measure.

In the course of using a tape measure, it is common practice to record in writing the dimensions of what has just been measured. At times, a convenient surface for recording dimensions may unavailable. Similarly, a writing tool or scribing implement may be lacking or nonfunctional, making the task of recording measurements impossible.

A number of solutions have been proposed to address the abovementioned problems. For example, U.S. Pat. No. 3,672,597 to Williamson describes a measuring instrument bearing a waxed plate with a transparent sheet and complicated stem-and-plunger mechanism enabling displacement of the transparent sheet from the waxed plate to clear memoranda noted on the plate. U.S. Pat. No. 5,845,413 to Zayat presents a measuring tape fitted with a built-in case suitable for containing a surface or substrate such as note paper upon which notes may be written. U.S. Pat. No. 3,838,520 to Quenot teaches a measuring tape may be fitted with an integrated frame containing a slidably mounted member serving as a means for effacing impressions made on a writing surface or substrate. Another attempt to provide a solution is presented in U.S. Pat. No. 4,786,010 to Dynan, which discloses a surface of the tape measure case designed to accept marking by a writing tool. In all these references, a fundamental requirement is that a writing tool of some sort be employed. Moreover, in the case of Dynan and Quenot, effacement of the marks made requires significant effort and manual dexterity. With reference to Dynan, the scribable surface is intended to be reusable, although the disclosure provides for effacing the markings with an abrasive material such as sandpaper. Williamson incorporates a somewhat complex mechanism for clearing the scribable surface, which not only increases part costs and manufacturing complexity, but also creates the prospect of the user's accidentally clearing notations, should the plunger assembly be inadvertently actuated when, for example, the tool is placed into an overloaded tool belt.

Other concepts have been employed in an attempt to provide an optimal solution. In U.S. Pat. No. 5,079,851 to Sill, a smooth surface is preferred to the more roughly textured surface disclosed in Dynan. However, Sill teaches that cleaning of the writing surface to enable the recordation of additional data is necessary, and that wet wiping of the surface to eliminate existing marks is preferred. U.S. Pat. No. 5,430,952 to Betts similarly discloses a surface for taking notes, but as in all of the foregoing examples still requires the use of a writing implement of some sort, thus providing only a partial solution to the dilemma many professionals and handymen often find themselves in when, for example, perched on a ladder with no substrate on which to record measurements or lacking a suitable writing implement.

In addition to the obvious disadvantage of requiring a writing tool, all of the aforementioned appear to require the physical act of erasure of marks. Such effacement may be effected by employing an eraser, a rag, or discarding the marked-up surface. Quenon appears to require for truly effective effacement of existing marks a lateral displacement of the writing surface by moving an exposed tab from a first to a second position, with a subsequent return of the same to the first position within a frame, potentially exposing the mechanism and writing substrate to damage. The Betts patent discloses a mechanism similar to that of Quenon, essentially a tape measure having a housing and a plastic pocket formed on the back surface of the housing, with the pocket capable of receiving a pad of block of paper used for note taking. As with Quenon, the chief problem associated with the tape measure disclosed by Betts in addition to the requirement of a stylus or other writing implement is that it is expensive to fabricate the pocket or fixture on the housing. Furthermore, a bulky profile results and negatively impacts the ergonomic aspects of the tool. Such a bulky tool may not fit in a tool belt or pocket conveniently, and a protruding tab may be inconvenient. The same problem is encountered in U.S. Pat. No. 5,575,506 to Gardenhour, Jr. which discloses a writing pad which is secured to a clip of a standard tape measure. Specifically, the writing pad is made from a substantially rigid material having a writing surface and an opening for receiving the clip of the tape measure therein. As illustrated in FIGS. 1 and 3 of Gardenhour, Jr. et al., the writing pad is awkwardly positioned on the tape measure and appears to interfere with its use. In addition, the writing pad must be erased prior to each use which, under certain circumstances, is inconvenient. Quenon is no different in that an additional, awkward physical action is required to erase the writing already on the surface before significant volumes of new measurements or other data may be recorded.

The foregoing illustrates limitations known to exist in present note-taking constructions associated with tape measures. Thus, it is apparent that it would be advantageous to provide an improved note-writing surface directed to overcoming one or more of the limitations set forth above. Accordingly, a suitable alternative is provided including features more fully disclosed hereinafter. Other objects, features and advantages of the invention shall become apparent as the description thereof proceeds when considered in connection with the accompanying illustrative drawings.

### BRIEF SUMMARY OF THE INVENTION

The present invention is directed to a combination tool combining a reusable, replaceable easily scribable and effaceable surface suitable for marking with notations, measurements or the like and a typical tape measure such as one comprising a box-shaped housing having a planar front wall, a planar back wall which is parallel to and spaced from the front wall, a top wall, a bottom wall, and a pair of end walls. The top, bottom and end walls are narrow in width with respect to the front and back walls. A spring-loaded tape reel is provided within the housing for dispensing tape through a horizontal aperture formed in one of the end walls. The scribable and effaceable surface comprises a writing surface of at least one base layer of a suitable, pressure-sensitive, heat-sensitive or electrically-sensitive substrate having a contact adhesive or magnetic coating on its rear surface, and coated on its front surface with a with a suitable layer of scribable surface or surface capable of displaying impressions or markings.

The scribable surface in one embodiment may consist in part of a substrate coated with a layer of microcrystalline wax or other suitable wax or wax-like material of suitable thickness, for example approximately 10 microns thickness, and at least one upper layer consisting a film of polyester or other suitable and preferably transparent material of suitable thickness—such as 40 microns thickness—such that impressions made on the top surface by any writing implement or simply by a fingernail cause the surface underneath to adhere temporarily along the pressure contact zone, so as to create a visible impression. In another embodiment, the scribable surface may consist of a substrate essentially comprised of a pressure-, temperature-, or electrically-sensitive surface such as a liquid crystal array comprised of a liquid crystal positioned between transparent, electrically conductive films. The scribable and effaceable surface is removably affixed to any of the front, back, top, and bottom walls of the housing of the tape measure by means such as an adhesive or magnetic surface.

Accordingly, among the several objects of the present invention are: the provision of a scribable and effaceable surface for note-taking for a tape measure capable of being reused repeatedly and replaced when necessary; the provision of such a scribable and effaceable surface for note-taking which locates this surface conveniently on the tape measure; the provision of such an improved scribable and effaceable surface for note-taking which is simple in design and easy to use; the provision of such a scribable and effaceable surface for note-taking which requires no tool save for a finger for making effective and useful markings such as figures or numerals relating to measurements, and the provision of such an improved note pad holder which is cost-efficient to manufacture and sell.

### BRIEF DESCRIPTION OF THE DRAWINGS

The following drawings are attached in explanation of the invention, the features of which are referenced within the detailed description of the invention.

FIG. 1 is a rear perspective view of a scribable and effaceable surface of the present invention combined with a tape measure of standard construction with the components comprising the scribable and effaceable surface being obscured by indicated by the broken lines;

FIG. 2 is an exploded view illustrating the scribable and effaceable surface prior to its securement to the tape measure and a note pad prior to its insertion into a pocket of the scribable and effaceable surface;

FIG. 3 is an elevational view of the scribable and effaceable surface and tape measure combination illustrated in FIG. 1 showing markings intentionally made and clearly visible on the scribable and effaceable surface;

FIG. 4 is an elevational view of the scribable and effaceable surface and tape measure combination illustrated in FIG. 1 showing the scribable and effaceable surface having been returned to a state free of markings.

Corresponding reference numerals are intended to be understood as designating corresponding parts throughout the several views of the drawings.

### DETAILED DESCRIPTION OF THE INVENTION

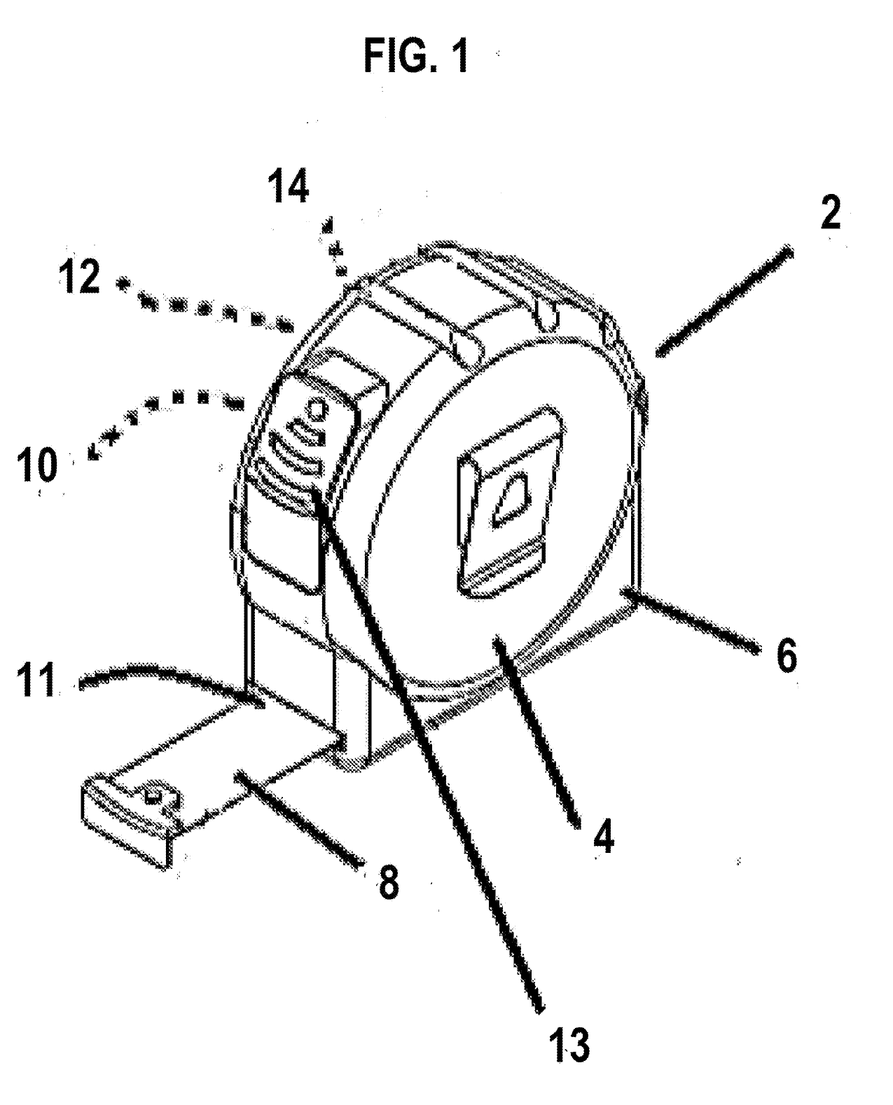

Referring to the drawings, and to FIGS. 1-4 in particular, there is generally indicated at 2 a combination tool consisting of a scribable and effaceable surface combined with a standard tape measure, generally indicated at 4. As most clearly shown in FIG. 1, the tape measure 4 is of standard construction, with a housing 6 is constructed of suitable materials, such as stainless steel or rigid plastic.

Referring specifically to FIG. 1, the tape measure 4 further includes a tape reel (not shown) disposed within the housing 6 in the conventional manner. The tape reel dispenses tape 8 through a thin aperture 11. The tape reel is constructed in such a manner that tape 8 pulled from the housing 6 of the tape measure 4 is retracted back into the housing 6 by a spring force. A sliding lock mechanism 13 is provided for locking the tape 8 in place so that the spring force on the tape reel does not recoil the tape 8. This construction is well known in the art of tape measures.

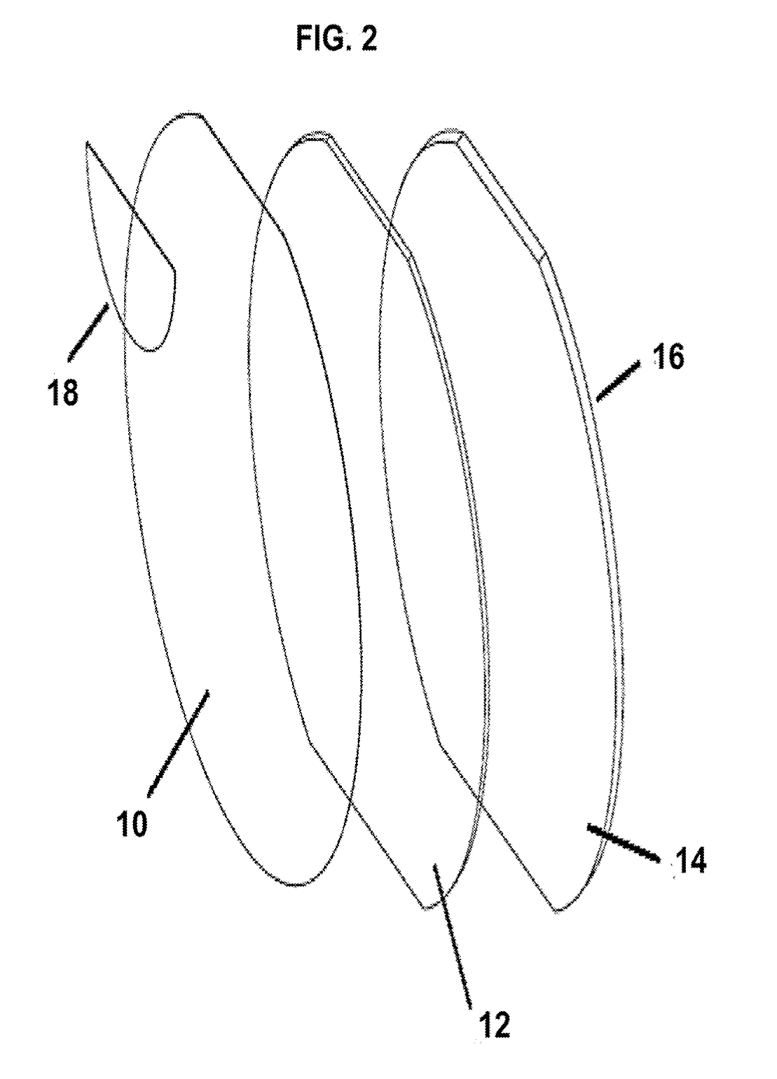

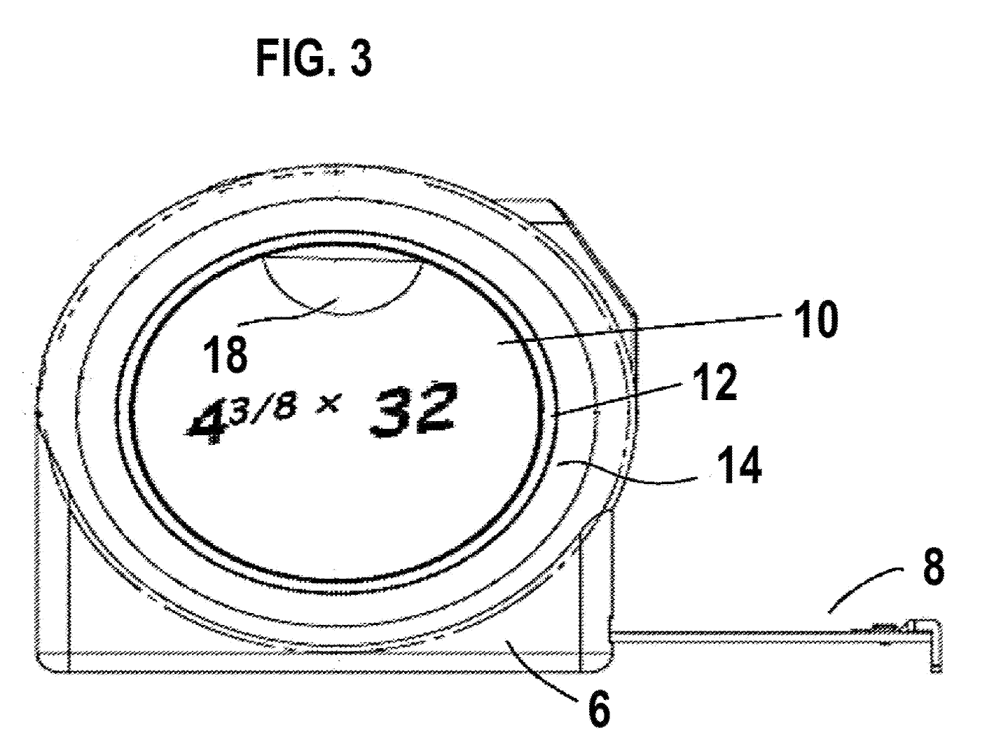

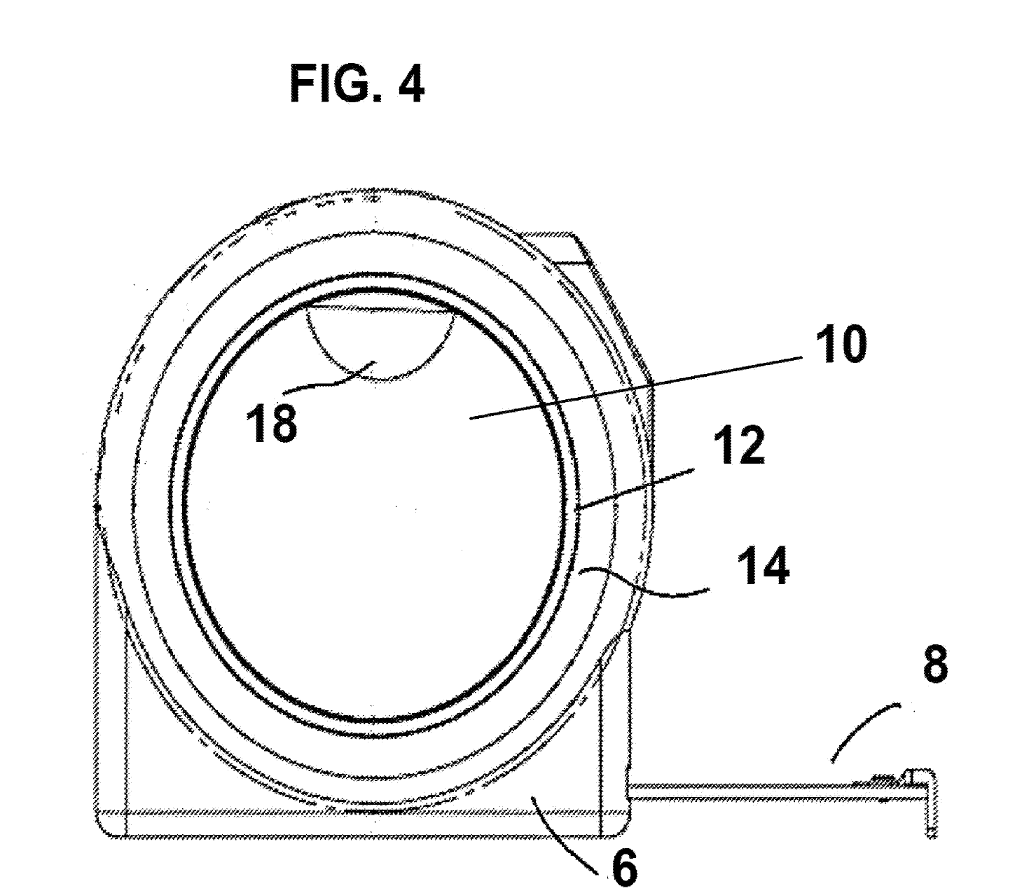

The scribable and effaceable surface seen most clearly in FIG. 2 is comprised of several the layers 10, 12, and 14 respectively being the durable, flexible and transparent outer layer 10, the temporarily adhesive, flexible, transparent middle later 12, and the base layer 14 bearing on the outward face proximate to the middle layer 12 a waxy composition and on the rear face indicated at 16 an adhesive coating. As illustrated in all of FIGS. 1-4 but best seen in FIGS. 3 and 4, the scribable and effaceable surface is constructed so as to provide an easily, temporarily marked surface, which may also be easily returned to a condition free of marks by lifting the c durable, flexible and transparent outer layer 10 with the tip of a finger. As shown in FIG. 3, the scribable and effaceable surface 10 is of the type which receives temporary impressions—indicated by the measurements inscribed thereupon—which can easily be removed by the partial separation by lifting of the temporarily adhesive, flexible, transparent middle layer 12 from the base layer 14. The component layers of the scribable and effaceable surface are connected to one another by the hinge member 18.

In an alternative embodiment, the scribable and effaceable surface comprised of the layers 10, 12, and 14 may also be formed as an adhesive- or magnetic-backed, liquid-crystal based pressure-sensitive substrate for allowing a person to take notes on the scribable and effaceable surface. The liquid crystal surface may be imprinted with direct pressure such as from any stylus or similar object, including a human digit, or may be marked with an electrical charge, for example as may be transmitted by a suitable stylus, or may change color or transparency or translucency depending on a temperature differential caused by contact with a stylus or a human finger. In all cases, such a surface may be returned to a first state from a second, marked state by an electric impulse or simply by returning to a rest state due to conditions of time or temperature.

Thus, it should be observed that the scribable and effaceable surface of the present invention is simple in design, leading to cost-effective manufacture, and highly effective for temporarily recording measurements or the lie without negatively affecting the utility of the tape measure. It can therefore be seen that the instant invention provides an advantage over the prior art. For these reasons, the invention is believed to represent a significant advancement in the art which has substantial commercial merit.

While there is shown and described herein certain specific structure embodying the invention, it will be apparent to one skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A combination tool measuring device of the type comprising a rigid housing and a helical, extendable, and retractable flexible ruled measuring tape therewithin, said housing comprising matched casing section components and means for connecting the same with a helical tape disposed therewithin, said housing having an outlet from which said helical measuring tape may be extended and into which the tape may be retracted, and throughout a major portion of its lateral faces capable of receiving a scribable and effaceable attachable and removable surface.

2. A combination tool measuring device according to claim 1 in which said scribable and effaceable attachable and removable surface comprises a base surface with an adhesive face suitable for attaching said scribable and effaceable surface to said housing and with an opposing surface coated with a microcrystalline wax layer, and having a second transparent, flexible layer disposed thereover, with a further durable, transparent flexible member disposed over said waxed surface and said second transparent, flexible layer, with all layers connected and bonded along a circumferential section, configured such that pressure momentarily applied linearly to said outermost durable, transparent flexible member will cause temporary adhesion of the underlying surfaces resulting in a visible mark or marks, instantly effaceable by the intentional separation of the layers.

3. A combination tool measuring device according to claim 1 in which said scribable and effaceable attachable and removable surface comprises a pressure-sensitive crystalline matrix layer embedded between a base layer coated on one surface with an adhesive, and a durable, transparent flexible member, with said crystalline matrix layer capable of temporarily retaining markings resulting from pressure momentarily applied linearly to said transparent flexible member.
